(19) United States
(12) Patent Application Publication
(10) Pub. No.: US 2014/0033832 A1
(43) Pub. Date: Feb. 6, 2014

(54) PRESSING ROLLER TESTING APPARATUS FOR PRINTER

(71) Applicant: HON HAI PRECISION INDUSTRY CO., LTD., New Taipei (TW)

(72) Inventors: WEN-HOW HUANG, New Taipei (TW); YEN-TAI CHEN, New Taipei (TW)

(21) Appl. No.: 13/912,494

(22) Filed: Jun. 7, 2013

(30) Foreign Application Priority Data
Jul. 31, 2012 (TW) 101127660

(51) Int. Cl. G01L 1/26

(52) U.S. Cl. CPC G01L 1/26
USPC 73/862.621

(57) ABSTRACT

A pressing roller testing apparatus for a printer includes a base, a duplexer module positioned on the base, and a resisting module fixed on the base. A paper pressing roller is fixed on the duplexer module. The resisting module includes a rotating axis, a rotating wheel mounted on the rotating axis, a pressure detecting unit mounted on the rotating wheel, a supporting block mounted on the rotating wheel, and a resisting block connected to the pressure detecting unit and the supporting block. A top surface of the resisting block contacts the paper pressing roller. A bottom surface of the resisting block contacts the pressure detecting unit. The rotating axis is rotated and the resisting block resists against the paper pressing roller. The paper pressing roller generates an elastic counterforce on the pressure detecting unit by the resisting block. The pressure detecting unit detects and output value of the counterforce.

### BACKGROUND

1. Technical Field

The present disclosure relates to a testing apparatus for testing pressing rollers of a printer.

2. Description of Related Art

A printing apparatus, such as a printer or a photocopying machine, feeds a sheet of paper from an input tray, prints an image on the sheet, and discharges the printed paper to an output tray. A duplexer module with a number of pressing rollers is used to transmit paper sheets in the printer. The pressing rollers of the duplexer module need to be tested before the printer is assembled. However, it may be difficult for the typical testing apparatus to test all of the pressing rollers due to limited space in the printer.

Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a pressing roller testing apparatus for a printer.

FIG. 2 is an exploded, isometric view of the pressing roller testing apparatus of FIG. 1, viewed from another aspect.

FIG. 3 is an exploded, isometric view of a resisting module of FIG. 1.

FIG. 4 is an isometric view of a supporting block of FIG. 3.

FIG. 5 is an assembled view of the pressing roller testing apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

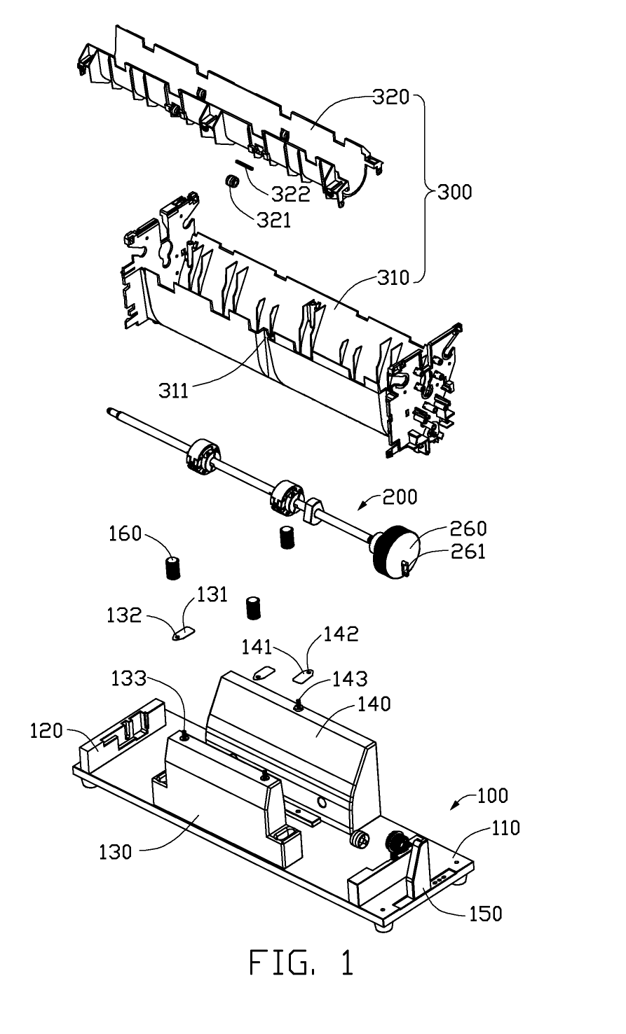

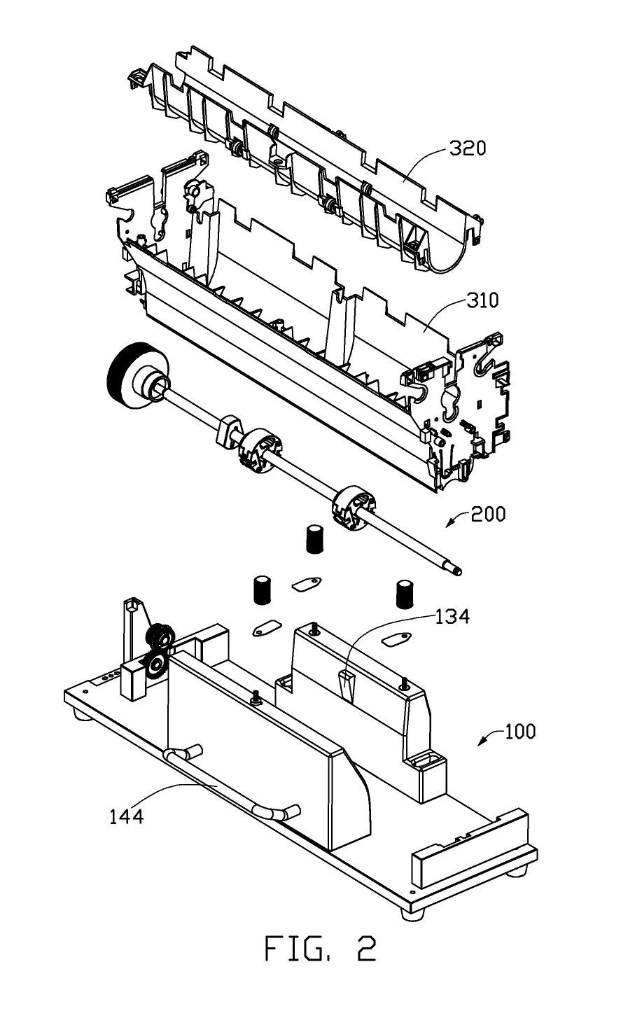

FIGS. 1 and 2 show a pressing roller testing apparatus for a printer includes a base 100 and a resisting module 200 fixed on the base 100. The resisting module 200 tests a duplexer module 300 positioned on the base 100.

The base 100 includes a bottom plate 110. A restriction plate 120 perpendicularly extend from each of a right side and a left side of the bottom plate 110. Each of a first fixing plate 130 and a second fixing plate 140 perpendicularly extends from each of a front side and a back side of the bottom plate 110. A restriction block 150 perpendicularly extends from the bottom plate 110 on one side of one restriction plate 120. Two first fixing slices 131 are movably installed on the first fixing plate 130. A first through hole 132 is defined on each of the two first fixing slices 131. Two first fixing portions 133 are positioned on the first fixing plate 130 corresponding to the first through holes 132. A fool proofing block 134 protrudes from the first fixing plate 130.

A second fixing slice 141 is movably installed on the second fixing plate 140. A second through hole 142 is defined on the second fixing slice 141. A second fixing portion 143 is formed on the second fixing plate 140 corresponding to the second through hole 142. A handle 144 is formed on the second fixing plate 140.

The first fixing portions 133 pass through the corresponding first through holes 132. The second fixing portion 143 passes through the second through hole 142. A plurality of first fasteners 160 are mounted on the first fixing portions 133 and the second fixing portion 143 to fix the first fixing slices 131 and the second fixing slice 141 on the first fixing plate 130 and the second fixing plate 140.

The duplexer module 300 includes a first mounting bracket 310 and a second mounting bracket 320 fixed on the first mounting bracket 310. A fool proofing slot 311 is defined in the first mounting bracket 310. Two paper pressing rollers 321 are fixed on two sides of the second mounting bracket 320. Each of the paper pressing rollers 321 are mounted on the second mounting bracket 320 by an elastic member 322.

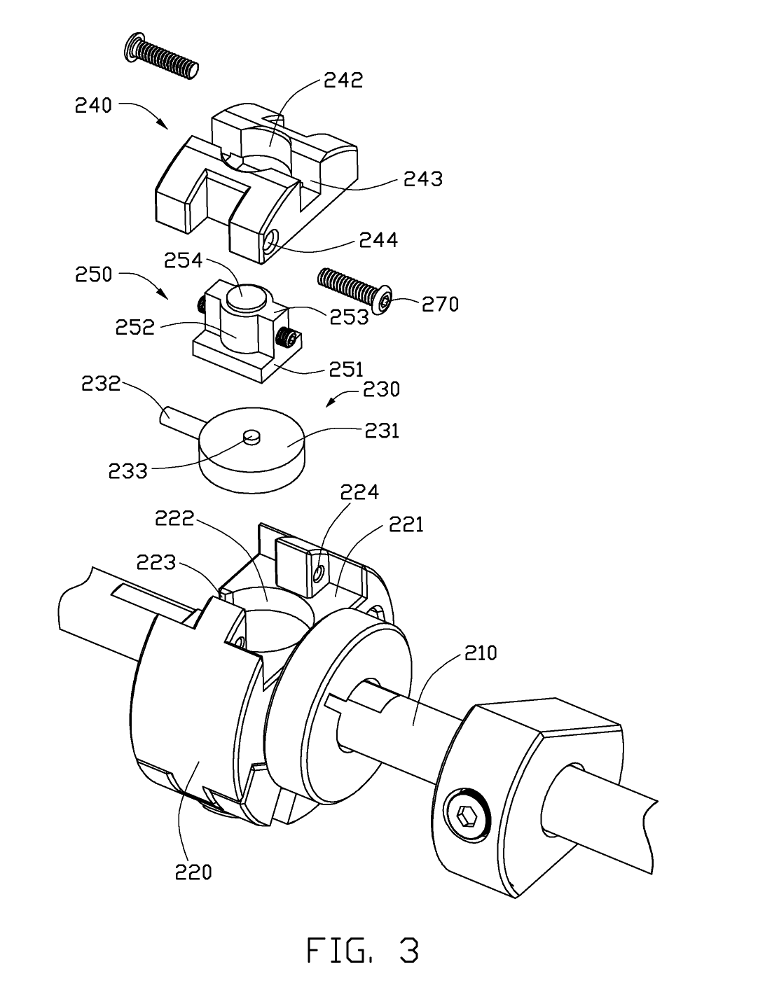

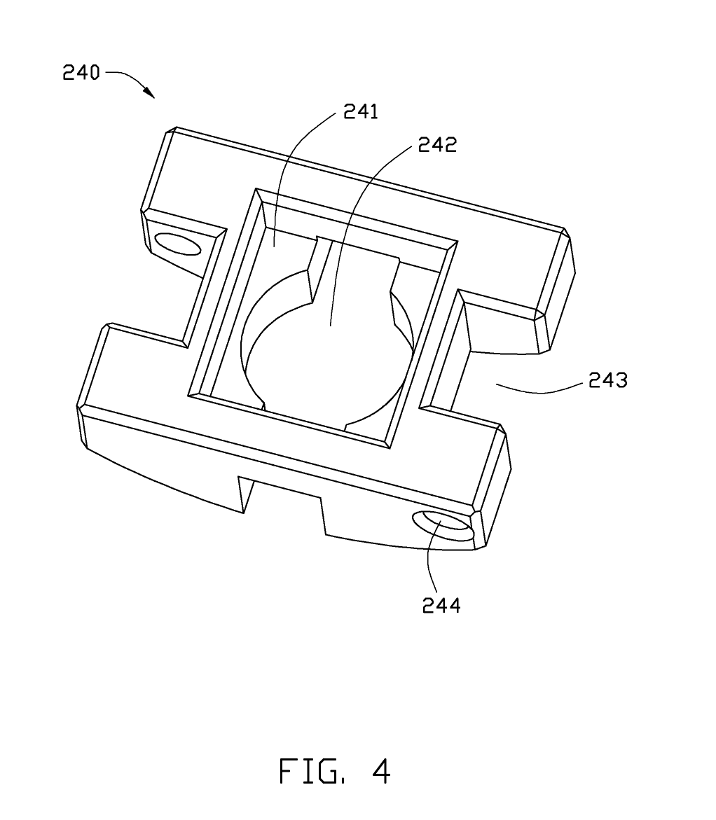

FIGS. 3 and 4 show the resisting module 200 includes a rotating axis 210 and two rotating wheels 220 mounted on the rotating axis 210. Two H-shaped first slots 221 are symmetrically defined in each of the two rotating wheels 220. A circular opening 222 and a cutout 223 are defined in each of the first slots 221. The opening 222 and the cutout 223 communicate with each other.

A pressure detecting unit 230 is mounted in the opening 222 and the cutout 223. The pressure detecting unit 230 includes a disk-shaped body 231. A column-shaped signal output pin 232 extends from one side of the body 231. A sensing protrusion 233 protrudes from a top surface of the body 231. The body 231 is received in the opening 222. The signal output pin 232 extends to outside of the rotating wheel 220 from the cutout 223.

A supporting block 240 is received in each of the first slots 221. A first accommodating space 241 is defined in a bottom of the supporting block 240. A second accommodating space 242 is defined in a top of the supporting block 240. A locating slots 243 is defined on each of two sides of the second accommodating space 242. The first accommodating space 241 and the second accommodating space 242 communicate with each other. Two third through holes 244 are defined on two sides of the supporting block 240. Two third fixing holes 224 are defined on two sides of each of the first slots 221, corresponding to the two third through holes 244.

A resisting block 250 is accommodated in the first accommodating space 241 and the second accommodating space 242. The resisting block 250 includes a base plate 251. A column-shaped connecting block 252 perpendicularly extends from the base plate 251. A locating block 253 extends from each of two sides of the connecting block 252. The base plate 251 and the connecting block 252 are accommodated in the first accommodating space 241 and the second accommodating space 242 respectively. Each of the locating blocks 253 is received in each of the locating slots 243. A disk-shaped contacting block 254 is formed at a top of the connecting block 252.

FIG. 1 shows a rotating knob 260 is formed on one side of the rotating axis 210. A restriction bar 261 protrudes from the rotating knob 260.

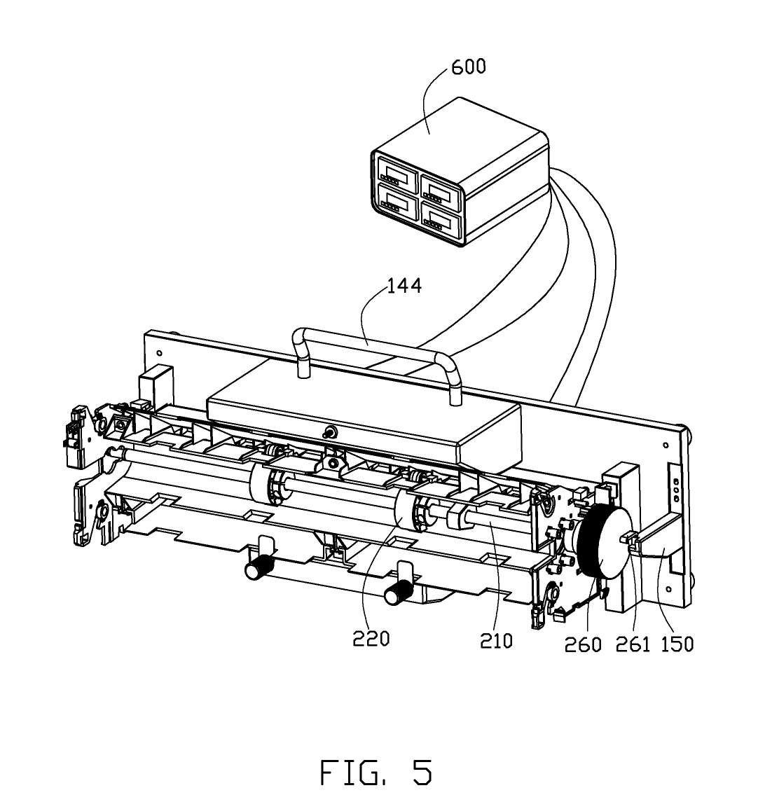

FIGS. 1 to 5 show that in assembly, the pressure detecting unit 230 is located in the opening 222 and the cutout 223. The body 231 is received in the opening 222. The signal output pin 232 extends out from the cutout 223. The resisting block 250 is located in the supporting block 240. The base plate 251 and the connecting block 252 are accommodated in the first accommodating space 241 and the second accommodating space 242 respectively. The locating blocks 253 are received in the corresponding locating slots 243. The resisting block 250 and the supporting block 240 are located in the first slots 221. The third through holes 244 are aligned with the corresponding third fixing holes 224. A plurality of second fasteners 270 pass through the corresponding third through holes 244 and the third fixing holes 224 to fix the supporting blocks 240 in the first slots 221. A bottom surface of the base plate 251 resists against the sensing protrusion 233.

The duplexer module 300 is located on the base 100. The fool proofing block 134 on the first fixing plate 130 is received in the fool proofing slot 311 on the first mounting bracket 310. The first fixing slices 131 and the second fixing slice 141 are rotated to resist against the first mounting bracket 310 and fix the duplexer module 300 on the base 100.

Two distal ends of the rotating axis 210 pass through two sides of the duplexer module 300. The rotating knob 260 is mounted on one distal end of the rotating axis 210 to fix the resisting module 200 on the duplexer module 300. The restriction bar 261 on the rotating knob 260 faces the restriction block 150 on the base 100.

In operation, the handle 144 is picked up to stand up the resisting module 200 and the duplexer module 300. The signal output pin 232 of each pressure detecting unit 230 is electrically connected to a pressure test equipment 600. The rotating knob 260 is rotated until the restriction bar 261 resists against the restriction block 150 on the bottom plate 110. The resisting block 250 on each rotating wheel 220 resists the corresponding paper pressing roller 321 by the contacting block 254. The elastic member 322 is elastically deformed. The elastic member 322 generates an elastic counterforce on the contacting block 254 by the corresponding paper pressing roller 321. The counterforce from the elastic member 322 is sensed by the sensing protrusion 233 on the pressure detecting unit 230 via the resisting block 250. The sensing protrusion 233 transmits the counterforce to the pressure test equipment 600 via the corresponding signal output pin 232. The pressure test equipment 600 displays value of the counterforce at the corresponding paper pressing roller 321 and determines whether the counterforce is normal.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A pressing roller testing apparatus for a printer comprising:
a base;
a duplexer module positioned on the base; a paper pressing roller being fixed on the duplexer module; and
a resisting module fixed on the base; the resisting module comprising:
a rotating axis;
a rotating wheel mounted on the rotating axis;
a pressure detecting unit mounted on the rotating wheel;
a supporting block mounted on the rotating wheel; and
a resisting block connected to the pressure detecting unit and the supporting block; wherein a top surface of the resisting block contacts the paper pressing roller; a bottom surface of the resisting block contacts the pressure detecting unit; when the rotating axis is rotated and the resisting block resists against the paper pressing roller, the paper pressing roller generates an elastic counterforce on the pressure detecting unit by the resisting block, and the pressure detecting unit detects and outputs a value of the counterforce.

2. The pressing roller testing apparatus of claim 1, wherein a first slot is defined in the rotating wheel; an opening and a cutout are defined in the first slot; the opening and the cutout communicate with each other; the supporting block is received in the first slot; the pressure detecting unit comprises a body; a signal output pin extending from one side of the body; a sensing protrusion protruding from a top surface of the body; the body is received in the opening; the signal output pin extends to an outside of the rotating wheel from the cutout; and a bottom surface of the resisting block resists against the sensing protrusion.

3. The pressing roller testing apparatus of claim 1, wherein a first accommodating space is defined in a bottom of the supporting block; a second accommodating space is defined in a top of the supporting block; a locating slot is defined on each of two sides of the second accommodating space; the first accommodating space and the second accommodating space communicate with each other; the resisting block comprises a base plate; a connecting block perpendicularly extending from the base plate; a locating block extending from each of two sides of the connecting block; the base plate and the connecting block are accommodated in the first accommodating space and the second accommodating space respectively; and each of the locating blocks is received in each of the locating slots.

4. The pressing roller testing apparatus of claim 3, further comprising a contacting block formed at a top of the connecting block, wherein the resisting block resists the paper pressing roller by the contacting block.

5. The pressing roller testing apparatus of claim 1, wherein the paper pressing roller is mounted on the duplexer module by an elastic member.

6. The pressing roller testing apparatus of claim 1, wherein the base comprises a bottom plate; each of a first fixing plate and a second fixing plate extends from each of two sides of the bottom plate; a first fixing slice is movably installed on the first fixing plate; a second fixing slice is movably installed on the second fixing plate; a fool proofing slot is defined in the duplexer module; the duplexer module is located on the base; the first fixing slice and the second fixing slice resist against the duplexer module; and the fool proofing block on the first fixing plate is received in the fool proofing slot on the duplexer module.

7. The pressing roller testing apparatus of claim 6, further comprising a restriction plate extending from each of another two sides of the bottom plate, wherein a restriction block extends from the bottom plate on one side of one restriction plate; a rotating knob is formed on one side of the rotating axis; a restriction bar protrudes from the rotating knob; the resisting module is fixed on the duplexer module; and the restriction bar on the rotating knob faces the restriction block on the bottom plate.

8. The pressing roller testing apparatus of claim 1, wherein the signal output pin of the pressure detecting unit is electrically connected to a pressure test equipment.

9. A pressing roller testing apparatus for testing a duplexer module of a printer comprising:
a base configured to support the duplexer module on the base;
a paper pressing roller configured to be fixed on the duplexer module; and
a resisting module fixed on the base; wherein the resisting module comprising:
a rotating axis;
a rotating wheel mounted on the rotating axis;
a pressure detecting unit mounted on the rotating wheel;
a supporting block mounted on the rotating wheel; and
a resisting block connected to the pressure detecting unit and the supporting block; wherein a top surface of the resisting block contacts the paper pressing roller; a bottom surface of the resisting block contacts the pressure detecting unit; when the rotating axis is rotated and the resisting block resists against the paper pressing roller, the paper pressing roller generates an elastic counterforce on the pressure detecting unit by the resisting block, and the pressure detecting unit detects and outputs a value of the counterforce.

10. The pressing roller testing apparatus of claim 9, wherein a first slot is defined in the rotating wheel; an opening and a cutout are defined in the first slot; the opening and the cutout communicate with each other; the supporting block is received in the first slot; the pressure detecting unit comprises a body; a signal output pin extending from one side of the body; a sensing protrusion protruding from a top surface of the body; the body is received in the opening; the signal output pin extends to an outside of the rotating wheel from the cutout; and a bottom surface of the resisting block resists against the sensing protrusion.

11. The pressing roller testing apparatus of claim 9, wherein a first accommodating is space defined in a bottom of the supporting block; a second accommodating space is defined in a top of the supporting block; a locating slot is defined on each of two sides of the second accommodating space; the first accommodating space and the second accommodating space communicate with each other; the resisting block comprises a base plate; a connecting block perpendicularly extending from the base plate; a locating block extending from each of two sides of the connecting block; the base plate and the connecting block are accommodated in the first accommodating space and the second accommodating space respectively; and each of the locating blocks is received in each of the locating slots.

12. The pressing roller testing apparatus of claim 11, further comprising a contacting block formed at a top of the connecting block, wherein the resisting block resists the paper pressing roller by the contacting block.

13. The pressing roller testing apparatus of claim 9, wherein the paper pressing roller is mounted on the duplexer module by an elastic member.

14. The pressing roller testing apparatus of claim 9, wherein the base comprises a bottom plate; each of a first fixing plate and a second fixing plate extends from each of two sides of the bottom plate; a first fixing slice is movably installed on the first fixing plate; a second fixing slice is movably installed on the second fixing plate; a fool proofing slot is defined in the duplexer module; the duplexer module is located on the base; the first fixing slice and the second fixing slice resist against the duplexer module; and the fool proofing block on the first fixing plate is received in the fool proofing slot on the duplexer module.

15. The pressing roller testing apparatus of claim 14, further comprising a restriction plate extending from each of another two sides of the bottom plate, wherein a restriction block extends from the bottom plate on one side of one restriction plate; a rotating knob is formed on one side of the rotating axis; a restriction bar protrudes from the rotating knob; the resisting module is fixed on the duplexer module; and the restriction bar on the rotating knob faces the restriction block on the bottom plate.

16. The pressing roller testing apparatus of claim 9, wherein the signal output pin of the pressure detecting unit is electrically connected to a pressure test equipment.
